(19) United States
(12) Patent Application Publication
(10) Pub. No.: US 2007/0291031 A1
(43) Pub. Date: Dec. 20, 2007

(54) THREE DIMENSIONAL GEOMETRIC DATA CORRECTION

(75) Inventors: Max Konev, Auckland (NZ); Mark Shafer, Auckland (NZ); Jed Fisher, Auckland (NZ)

Correspondence Address: VIERRA MAGEN MARCUS & DENIRO LLP, 575 MARKET STREET SUITE 2500, SAN FRANCISCO, CA, 94105, US

(73) Assignee: RIGHT HEMISPHERE LIMITED, Auckland (NZ)

(21) Appl. No.: 11/672,437

(22) Filed: Feb. 7, 2007

Related U.S. Application Data
(60) Provisional application No. 60/804,917, filed on Jun. 15, 2006.

(51) Int. Cl. G06T 15/30

(52) U.S. Cl. 345/423

(57) ABSTRACT

Technology creates visualization data which corrects defects present in the native application data created by a CAD or other graphic application. A computer implemented process creates three dimensional object view data, and includes the steps of: accessing a three dimensional object data comprising a plurality of polygons having borders; building a border collapsion heap, the border collapsion heap comprising pairs of border elements separated by a distance; and joining one or more pairs of border elements based on a separation distance.

### CLAIM OF PRIORITY

This application claims the benefit under 35 U.S.C. §120 of U.S. Provisional Patent Application No. 60/804,917, entitled “Geometry Repair and Simplification Process”, filed Jun. 15, 2006.

### BACKGROUND OF THE INVENTION

### Description of the Related Art

Computer aided design (CAD) tools have become standard in many industries. Such tools are used in designing everything from buildings to micro-machines. Generally, designs are created in two dimensional drawings which might include various individual piece drawings as well as assembly and view drawings.

It is often useful when working with design drawings to view three dimensional representations of the objects in the drawings. Three dimensional (3D ) visualization of objects is useful in a variety of contexts. For example, CAD designs can be converted to 3D representations to allow designers a better understanding of the element being designed.

Typically, when a CAD model is subjected to three dimensional (3D) visualization, the CAD model suffers from sloppy geometry—there are cracks and holes in its surfaces, gaps exist between adjacent surfaces, surfaces overlap, or solid objects have disjointed pieces. This defective geometry is due to CAD artifacts and may preclude the use of many visualization algorithms that require closed models.

Moreover, when attempting to create a “real time” 3D renderings, these errors in the geometry require computationally intensive correction. CAD data is typically very large in size because it contains engineering data that is computationally expensive to render but unnecessary for visualization. If such data remains large, then the graphics hardware will be slow to draw the rendering, and may not draw quickly enough for interactive performance.

Repair techniques targeted for engineering purposes such as computation fluid dynamics (CFD) can be used to solve visualization errors, but are actually meant to satisfy different needs. The repair process in a pure engineering context is to ensure that models are ‘watertight’ to enable further computations to be performed on them. In this case geometric exactness is primary and the models may well end up being larger in terms of data. Therefore the engineering-based repair techniques are not designed as a step towards visualization or performance but rather accuracy. With CFD, for example, it is more important that the model is mathematically ‘watertight’ (gaps are fixed, surfaces are properly joined) than perceptually correct. A watertight model can still produce visualization artifacts and/or be highly inefficient for rendering due to the use of surplus geometry to repair surfaces.

### SUMMARY OF THE INVENTION

The invention, roughly described, comprises a system and method for healing three dimensional visualization data. The technology creates visualization data which has corrected defects present in the native application data created by a CAD or other graphic application.

In one aspect, the technology includes a computer implemented process for creating three dimensional object view data, comprising: accessing a three dimensional object data comprising a plurality of polygons having borders; building a border collapsion heap, the border collapsion heap comprising pairs of border elements separated by a distance; and joining one or more pairs of border elements based on a separation distance.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 is a block diagram of one embodiment of a system for implementing the present technology.

FIG. 2 is a block diagram of a processing system which may be utilized in accordance with the present technology.

FIG. 3 is a flowchart indicating a first method for a 3D Object healing in accordance with the present technology.

FIG. 4 is an illustration of a boundary mapping array relative to a set of polygons used in accordance with the method shown in FIG. 3.

FIG. 5 is a flowchart showing the method of detecting boundary vertices used in the method of FIG. 3.

FIG. 6 is an illustration of the boundary vertex mapping relative to the polygon structure shown in FIG. 4.

FIG. 7 is a flowchart indicating a step of spatially mapping boundary used in the method of FIG. 3.

FIG. 8 is an example of the special mapping array relative to the polygon structure shown in FIG. 4.

FIG. 9 is a flowchart illustrating the step of building a vertex collapsion heap illustrated in FIG. 3.

FIG. 10 is a flowchart indicating the step of processing a collapsion heap discussed above with respect to FIG. 3.

FIG. 11A is an illustration of the polygonal structure of FIG. 4 and the vertex collapsion heap built in step before vertex contraction

FIG. 11B is an illustration of the polygonal structure of FIG. 4 after vertex contraction.

### DETAILED DESCRIPTION

Technology is disclosed for creating data which is optimized to allow a viewer to provide three dimensional visualization of CAD objects. The optimized data is created from original CAD data wherein common defects in visualization of the original CAD data are corrected. The technology is suited to processes such as polygon reduction, normals unification, radiosity, ray-tracing, illustration, and shadow volumes. These processes are important aspects of 3D visualization but their algorithms may not operate on non-closed models (due to faulty geometry) or will produce unacceptable artifacts. The technology presented herein provides a healing process as an initial step for efficient and accurate rendering.

The need for healing is the result of the way that CAD (or other badly designed) models originally arrive to the visualization system. Visualization does not function well unless some repair of deficient geometry occurs. Healing should occur early in the visualization operation. This places constraints on the approach towards healing that can be adopted. The technology herein performs healing in to provide polygon reduction making rendering performance better and allows orientation of normals in such as way that lighting and reflection calculations are correct. This approach is superior to standard engineering-based repair approaches whose algorithms may not operate on non-closed models (due to faulty geometry) or will produce unacceptable artifacts. Healing, is therefore required as an initial step for efficient and accurate rendering.

The technology uses iterative greedy vertex-to-vertex and vertex-to-edge contractions while maintaining a list of possible contractions for each step to prevent erroneous contractions. Automation of the healing process is also realized as the technology is designed to yield exceptional results without operator intervention. Moreover, it succeeds with a wide variety of CAD formats and associated geometry errors.

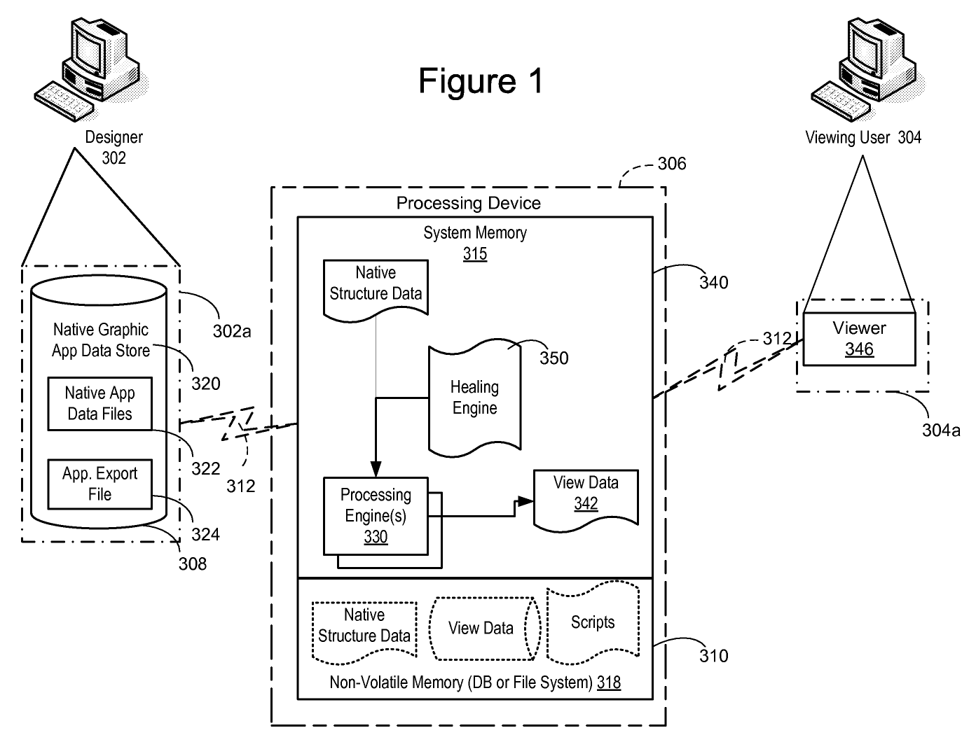

FIG. 1 illustrates a system for creating an optimized view data for 3D object visualization. FIG. 1 is a block level diagram illustrating certain functional components and data structures utilized in the system suitable for implementing the present technology. In one embodiment, a processing device 306 may be employed as a server which stores native graphic application data, employs a healing engine to create modified object view data, and outputs the data to a viewer. The native data may be provided by a designer 302 using another processing device 302a, or the designer may create the native data on the processing device 306. Likewise, the viewer 346 may be provided on another network coupled processing device 304a, or the viewer may operate on device 306. It should be understood that the components of FIG. 1 can be implemented on a single processing system or multiple processing systems.

In one embodiment, designer 302 will create an object design in a native graphic application which stores the design in native application data file or files 322 in data store 320 associated with the application. The native CAD data may be comprised of data from a number of different applications such as AutoCAD, Microstation, SolidWorks, etc., all of which have data in a native format which is accessible in a data store 320 directly by the application. The native data may be alternatively be stored on a file system in data files or may be exported to alternative file formats 324 such as IGES (a commonly used widely read CAD solids format.)

Native application data files or the application data export file 324 may be provided to a processing system 306 to implement the healing technology discussed herein.

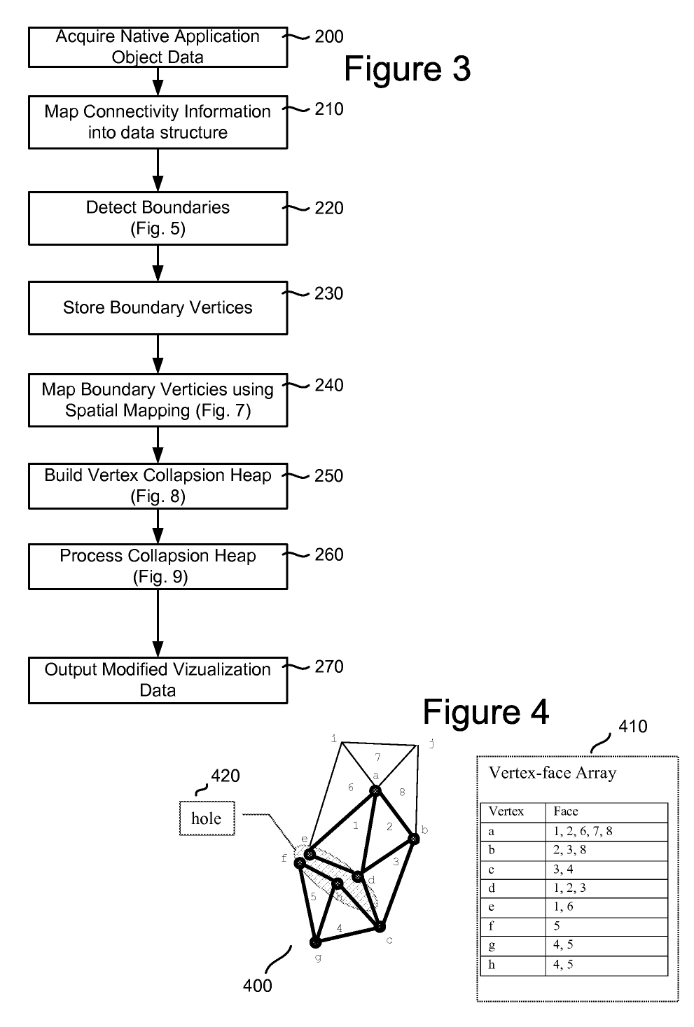

The processing system 306 may include non-volatile memory 310 and system memory 315. As will be generally understood by one of average skill, the components of the system operating in system memory may be stored in non-volatile memory 318 and loaded into system memory at run time as instructed by a system control (not shown). System memory 315 may include a healing engine performing the tasks described in FIGS. 3-11B to take native application data for the object (or application export file data) and provide healed visualization data. In one embodiment, the healing engine comprises a series of instructions to instruct processing engines 330 to provide healed view data 342. The healed visualization data may be provided by a network 312 to viewer 346 for interpretation by user 304. It should be further understood that the user 304 and graphical designer 302 may be the same individual.

In one embodiment, the processing environment for a system 310 is a client server/network environment such that graphical designer 302 has a unique processing system including a storage unit 308 which houses native graphical data and user 304 has a unique processing system which includes a viewer 346 and communicates with a server 306, itself comprising a unique processing system, via a network communication mechanism 312. It will be readily understood that the network communication mechanism may comprise any combination of public or private networks, local networks and alike such as the Internet. Still further user 304 may have its own unique processing system which includes the viewer. Alternatively, the user 304, designer 302, data and viewer may all reside on and interact with a single processing system.

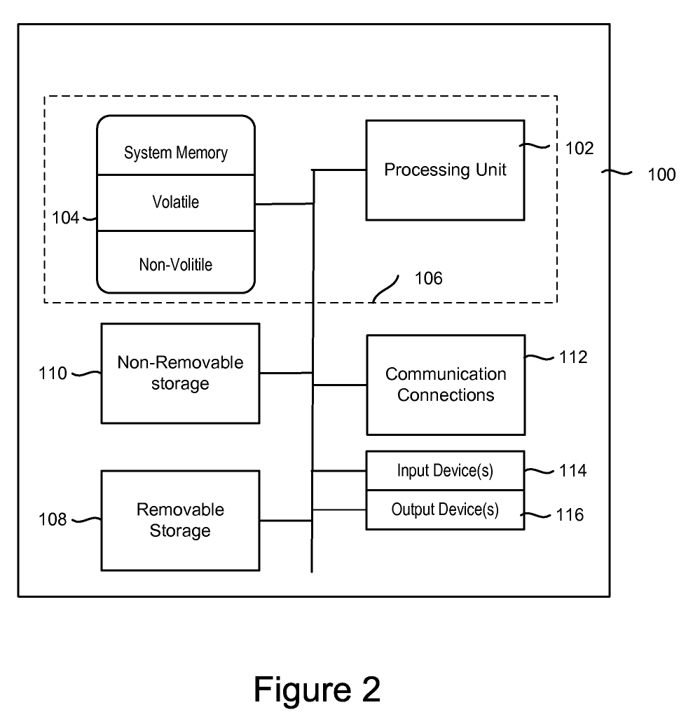

With reference to FIG. 2, an exemplary processing system used in the system of FIG. 1 for implementing the invention includes at least one computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. All these devices are well know in the art and need not be discussed at length here.

FIG. 3 illustrates a method which may be performed by the healing engine 350 to create modified visualization data which may be used by the viewer to render a three dimensional view of, for example, a CAD design.

At step 200 in FIG. 3, 3D object data in its native format or in the application export file 324 is imported into system memory 315 for use by the method FIG. 3. A simplified 3D object 400 is illustrated in FIG. 4. Each 3D object consists of a plurality of polygons which are joined at edges, the edges meeting at vertices. In FIG. 4, a series of faces 1-8 are connected to each other at a plurality of edges which are joined at a series of vertices A-J: vertex A is connected to faces 1 to 6, 7, 8; vertex B to faces 2, 3, 8 and so on. Also illustrated in FIG. 4 is a hole 420 which exists between faces 1 and 5 and 3 and 4. Vertices E, F, D and H surround the whole, and as discussed below, are candidates to be collapsed. In accordance with the technologies discussed herein, a method for detecting this hole and a method for correcting this corruption of the object data are provided.

At step 210, connectivity information of the vertices is mapped into a data structure 410. In this step, each vertex in the 3D CAD model 400 is entered into an array and linked to a set of faces of which the vertex is a member. The faces 1-8 linked to the respective vertices a-h are illustrated in structure 410.

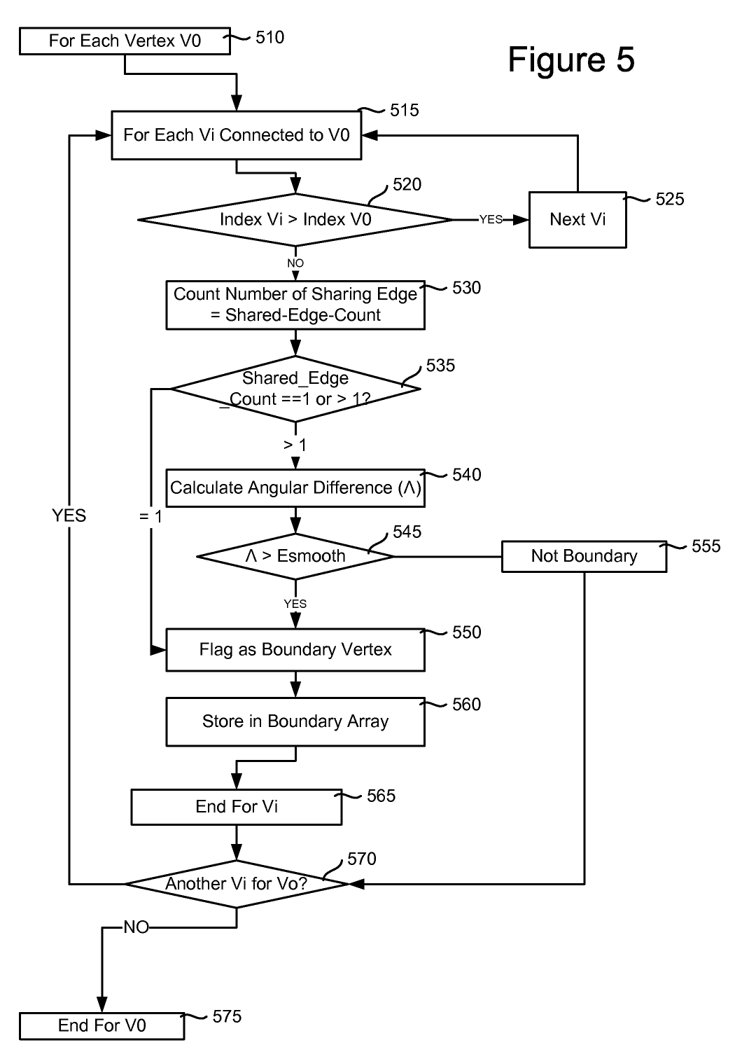

At step 220, boundaries between respective polygons in the surface geometry are detected. Boundaries comprise discontinuities in the surface geometry and boundary detection occurs over the set of points in the vertex array. Boundary vertices are selected on the basis of two criteria: the “single face rule” and the “sharp gradient” rule. Under the single face rule, a boundary vertex is a vertex on an edge that belongs to only one face. Under the sharp gradient rule, a boundary vertex is a vertex on the edge of two faces with a large angular difference in their slope. The method for detecting boundaries is illustrated in FIG. 5.

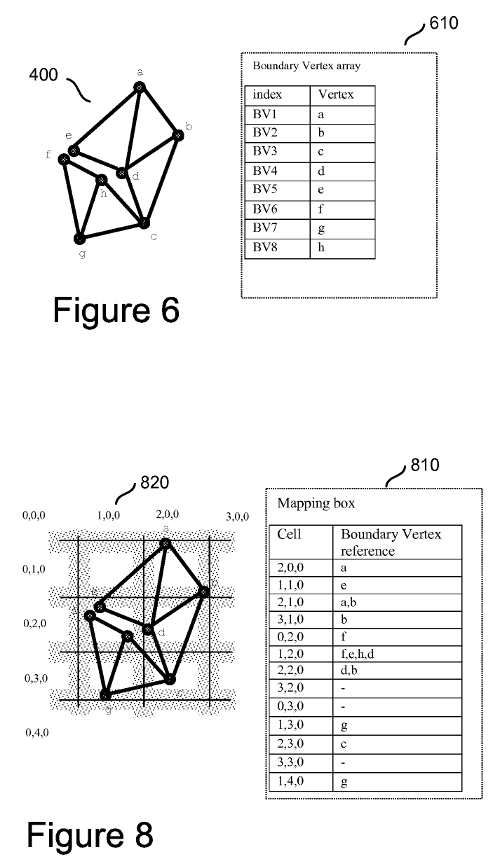

Once boundaries are detected, those vertices that belong to boundary edges detected in step 220 are stored at step 230 in a boundary vertex array. An exemplary boundary vertex array 610 for object 400 is illustrated in FIG. 6. The boundary vertex array 610 defines a reduced candidate set for efficient searching, and allows elimination of redundant calculations during later steps of the technology. The rationale of capturing boundary vertices lies within the nature of geometric defects requiring repair: it is only along surface edges that gaps, holes, or overlaps will occur. Non-boundary vertices are already well-connected and require no further repair. The complexity of the healing problem is considerably reduced for the reduction of the problem surface space.

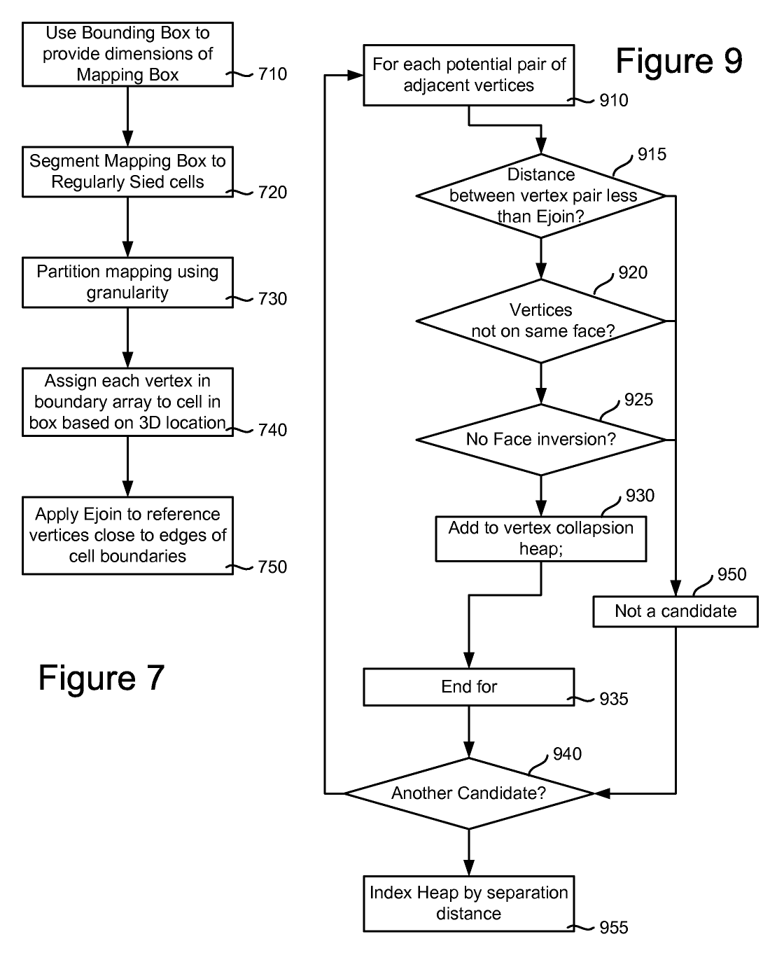

At step 240, boundary vertices are then spatially mapped using a three-dimensional grid, referred to herein as a spatial mapping box. An exemplary spatial mapping box 810 is shown in FIG. 8. The spatial mapping box greatly increases the efficiency of the healing algorithm by taking advantage of the localized nature of the geometric defects. Defects such as a cracks, holes, and surface overlap will have boundary vertices that are in close spatial proximity. Such defects are candidates for repair through vertex to vertex collapsing of neighboring boundary vertices as described below. In this case, the technology solves the healing problem on a localized basis providing considerable computational advantages. The search for geometric defects in candidate vertex to vertex collapses does not involve all boundary vertices, but only those contained in a particular cell of the three-dimensional grid. The spatial mapping process is discussed with respect to FIG. 7.

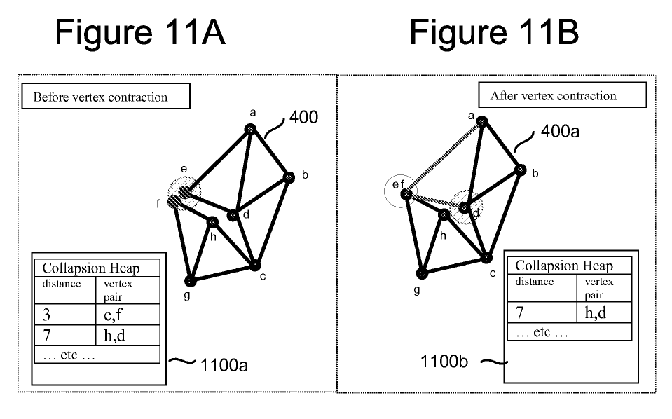

Once the boundary vertices have been spatially mapped at step 240, a vertex collapsion heap is built at step 250. The vertex collapsion heap represents those vertex pairs that can be potentially joined together to simplify and repair geometric errors. This allows building an abstracted clean service representation from only those vertices that are significant to the description of model geometry. Building of the vertex collapsion heap is discussed with respect to FIG. 8. An partial example of a collapsion heap 1100a is illustrated in FIG. 11A.

Finally, once the vertex collapsion heap has been built at step 250, the heap is processed at step 260 to collapse those elements which are suitable for collapsion as described in FIG. 9. The result is modified visualization data which is provided at step 270. The resulting collapsion of adjacent vertices is illustrated in FIGS. 11A and 11B, where structure 400 illustrates a polygonal structure before the vertices are collapsed and structure 400a illustrates the polygonal structure after the vertices are collapsed. The data output at step 270 can then be provided to a viewer 346 to provide a 3D visualized view of the object data.

FIG. 5 illustrates the process for detecting boundaries at step 220 above. As noted above, a boundary vertex is defined as a vertex that is on an edge belonging to only one face, or on the edge of two faces or the large angular difference in the slope between them. As illustrated in FIG. 5 two FOR loops are utilized. The base vertex V₀ in the vertex array is analyzed relative to each vertex Vᵢ connected to the base of V₀. For each vertex V₀ (step 510) and for each vertex Vᵢ connected to V₀, (step 515), a determination is made at step 520 as to whether the index of Vᵢ is greater than the index of V₀. If so, the process proceeds to the next connected vertex at step 525. This step 520 improves the efficiency of the algorithm and in a sense avoids redundant processing of the same edge. In the example shown in FIG. 4, if A is a base vertex, one looks to each face 1, 2 to determine each face edge connected to the base vertex (for example, AD, AE; AB AD) and the opposite end vertex (D, E, B, D is selected in turn.) Each of the vertexes D, E, B and D is in this case Vᵢ for each V₀ (A). If at step 520 the index of Vᵢ is greater than the index of V₀ then at step 530, a count is made of the number of sharing edges and this is set as the shared edge count. At step 535, a test is made to determine whether or not the shared edge count is equal to or greater than 1. If the shared edge count is equal to one the edge is flagged as a boundary vertex at step 550. If the shared edge count is greater than one then at step 540, the angular difference between the two edges under consideration (Λ) is calculated. At step 545, a smoothing distance (Eₛₘₒₒₜₕ) is used as a threshold for edge differences to be considered discontinuous; Eₛₘₒₒₜₕ is a user adjustable parameter. If Λ is greater than Eₛₘₒₒₜₕ then at step 550 V₀ is flagged as a boundary vertex. A large Λ represents a large change in slope between adjacent faces. If at step 545 Λ is not greater than the Eₛₘₒₒₜₕ, V₀ is set as not a boundary at step 555. At 560, if V₀ has been flagged as a boundary vertex, it is stored in a boundary array and the loop continues to the next Vᵢ at step 570.

An example of a boundary vertex array is shown in FIG. 6. In the exemplary polygon 400, each of the vertices in a boundary vertex array is a boundary vertex. It will be understood that in many objects, any number of vertexes will be present which do not represent boundary vertexes. As noted above, the boundary vertex array defines a reduced candidate set for efficient searching eliminating redundant calculations during later steps.

Returning to FIG. 3, once the boundaries are detected and stored in a boundary vertex array, at step 230, the boundary vertices are mapped using spatial mapping. This spatial mapping process is described with respect to FIG. 7.

At step 710, the 3D object's bounding box is used to provide the dimensions of the mapping box. A bounding box 820 is a cuboid containing the object, as illustrated at FIG. 8. At step 720, the mapping box is segmented into regularly sized cells. At step 730, the mapping box is partitioned using a granularity determined by the shape of the bounding box and constrained to produce a total number of cells that is computationally optimal. The optimal parameter may be determined through empirical study. Partitioning of the mapping box comprises assigning a number and size of slices along the x y coordinate axes.

At step 740, each vertex in the boundary vertex array is assigned a reference to one or more cells in the mapping box based on its 3D location in the 3D model under consideration. This is illustrated in the vertex array sample 810 shown in FIG. 8. At step 740, a tolerance factor is applied such that vertices that are close to the edges of cell boundaries are also referenced in adjacent cells. This tolerance factor (Eⱼₒᵢₙ) is the largest distance between vertices that should be joined. In one embodiment, it is set to 1% of the longest diameter of the model bounding box. At step 750, Eⱼₒᵢₙ is applied to reference vertices to close edges of the cell boundaries. At the completion of the process of FIG. 7, each cell in the mapping box is a list of references to any boundary vertex that it contains, taking tolerance into account. In the boundary vertex array shown in FIG. 8, for example, boundary vertex reference A is mapped to cell 2, 0, 0; vertices D and B to cell 2, 2, 0, and so on. Some cells may be empty.

Returning to FIG. 3, at step 250, a vertex collapsion heap is then built from a set of boundary vertices discovered and mapped in step 240. FIG. 9 illustrates the process of building a vertex collapsion heap. Brief examples of the vertex collapsion heap are shown in the before vertex contraction collapsion heap 1030 illustrated in FIG. 11A and 11B.

With reference to FIG. 9, the vertex collapsion heap is built by iterating over the boundary vertices contained in each of the cells of the mapping box. Each potential pairing of adjacent vertices is tested for qualification as a vertex collapse candidate. The number of pair wise combinations that have to be performed is therefore restricted to the same cell, greatly improving the efficiency of the computation. For each potential pair of adjacent vertices (step 910), a test is made at step 915 to determine if the distance between the vertex pair is less than a join threshold (Eⱼₒᵢₙ). If not, the pair is not a candidate at step 950. If the distance is less than the joined threshold, then a test is made at step 920 to determine if the vertices are not connected with the same face, and if so, a further test is made to determine whether or not there is any face inversion at step 925. At step 925, the determination is whether joining the faces would result in any change in the face orientation in the model. Face inversion is determined by testing the sign of the normals for each face before and after vertex joining. If steps 915, 920 and 925 are all true, the candidate vertex pair is added to the vertex collapsion heap and the next potential pair of adjacent vertices is tested. If another candidate is not present, the method returns to step 910. When all candidate pairs have been added to the heap, the vertex heap is indexed by separation distance at step 955. The process loop between steps 910 and 935 continues until all candidates for the model are added to the collapsion heap.

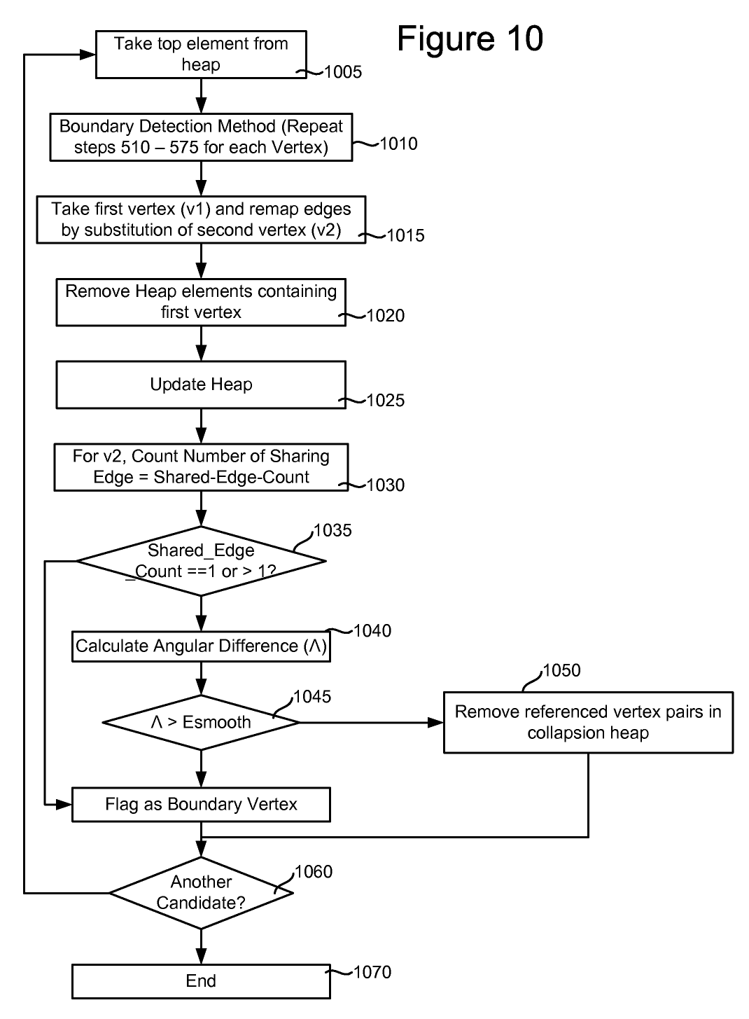

Once the collapsion heap is built at step 250, it is processed at step 260. Processing of the collapsion heap is illustrated with respect to FIG. 10.

At step 1005, a top element from the heap is evaluated. At step 1010, the boundary edge determination may be performed by evaluating the first pair to ensure that both vertices in the pair still satisfy the boundary criteria. This is completed by, for example, completing steps 510 through 575 illustrated in FIG. 5 for each of the vertices in the candidate pair. If both candidates pass the boundary detection verification at step 1010, then the two vertices are joined together by taking a first vertex (V₁) and remapping the edges of its associated faces by substitution of the second vertex for the first vertex. As illustrated in FIG. 11B, a first vertex E is remapped by substitution of the second vertex F and the original triangle (E, A, D) becomes F, A, D. At step 1020, any heap elements that contain the first vertex ((E) in the above example) are removed since it has now been collapsed into the second (F). At step 1025, the heap is updated and at step 1030, for all instances of the second vertex V₂ all contractions of the second vertex are reevaluated. Due to possible connection of additional faces through vertex contraction or remapping, the second vertex may no longer lie on a boundary. If it is no longer on a boundary, then the method would not want to join any other vertices with it. Steps 1030 through 1055 illustrate the process of determining whether or not vertices V₂ is still a boundary and are equivalent to steps 530, 535, 540, 545, 550 and 555 in FIG. 5. Again, this is necessary for keeping the key value valid and if this vertex (V₂) does not belong to a boundary any longer, another candidate for a source vertex will be found. At step 1060, if another candidate V₀ is found, then the process continues until all candidates on the collapsion heap are exhausted.

In an optional embodiment, the process of FIG. 10 may be repeated for all edges. Normally at this point in the computation process, many boundary vertices are already joined so the boundary edge determination is much less complex. At this juncture, the boundary vertex is determined and the closest boundary edge to it found. The key in this embodiment is to determine the shortest distance from the vertex to the edge. In this case, the edge and contraction should not collapse a valid face and an inversion check should be made to determine when inversion will exist upon collapsing the vertices with the edge.

The technologies disclosed herein may be extended to complex model healing with a stand-alone algorithm where virtual vertex to vertex and vertex to edge contraction pair lists can be defined and maintained during the hole healing process. The process can be applied to remove hanging triangles utilizing a small change in special case detection and contraction/deletion. Hanging triangles are a common artifact that arise from poor tessellation settings. Under normal situations, without explicit checking for face slipping, inversions or surface discontinuities may be introduced into the geometry. This is a deficiency of other healing algorithms. The tessellation process can also introduce inverted geometry. The technology herein can be extended to detect and repair these particular geometric inversion errors due to poor tessellation settings.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A process for correcting errors in a three dimensional view of an object, the view comprising a plurality of polygons, comprising:
spatially mapping boundary vertices between the polygons;
creating a vertex collapsion heap based on the spatial mapping;
processing the collapsion heap by collapsing pairs of boundary vertices within a defined distance.

2. The process of claim 1 wherein the process further includes mapping connectivity information into a data structure and detecting boundary vertices.

3. The process of claim 1 wherein the step of mapping comprises establishing a bounding box for the object, segmenting the bounding box into regularly sized cells based on a granularity setting.

4. The process of claim 3 wherein the granularity setting is user defined.

5. The process of claim 3 wherein the process further includes storing vertices that are adjacent to cell boundaries with adjacent cell information by applying a tolerance factor.

6. The process of claim 3 wherein the step of building a vertex collapsion heap includes storing pairs of boundary vertices within each cell.

7. The process of claim 1 wherein the step of creating a vertex collapsion heap comprises at least one or more of the steps of: determining whether the distance between members of a vertex pair is less than a tolerance factor; determining that members of a vertex pair are not on the same polygon face; determining that no face inversion exists between members of the pair.

8. The process of claim 7 wherein the step of creating a vertex collapsion heap comprises all of said determining steps.

9. The process of claim 1 wherein the step of processing the collapsion heap includes for at least a first vertex pair, substituting a second vertex for a first vertex in the pair.

10. The process of claim 9 wherein the step of processing includes removing any heap elements containing said first vertex.

11. The process of claim 9 further including the step of determining a whether the substituted second vertex is a boundary vertex.

12. A computer implemented process for creating three dimensional object view data, comprising:
accessing a three dimensional object data comprising a plurality of polygons having borders;
building a border collapsion heap, the border collapsion heap comprising pairs of border elements separated by a distance;
joining one or more pairs of border elements based on a separation distance.

13. The computer implemented method of claim 12 wherein the border elements are vertices.

14. The computer implemented method of claim 12 wherein the border elements are edges.

15. The computer implemented method of claim 12 further including the step of mapping boundary vertices between polygons comprising the three dimensional object.

16. The computer implemented method of claim 15 wherein the process further includes storing vertices that are adjacent to cell boundaries with adjacent cell information by applying a tolerance factor.

17. The computer implemented method of claim 12 wherein the step of creating a border collapsion heap comprises at least one or more of the steps of: determining whether the distance between members of an element pair is less than a tolerance factor; determining that members of a element pair are not on the same polygon face; determining that no face inversion exists between members of the pair.

18. The computer implemented method of claim 17 wherein the step of creating an element collapsion heap comprises all of said determining steps.

19. The computer implemented method of claim 12 wherein the step of joining includes for at least a first element pair, substituting a second element for a first element in the pair.

20. A computer readable medium having instructions stored thereon, the instructions causing a processing device to execute a method comprising:
mapping connectivity information for polygons comprising a three dimensional object into a data structure;
detecting boundary vertices joining the polygons;
spatially mapping the boundary vertices into a vertex face array;
building a vertex collapsion data structure containing pairs of boundary vertices;
joining a first vertex with a second vertex in ones of said pairs of boundary vertices; and
outputting corrected three dimensional object data for a viewer.

21. The computer readable medium of claim 20 wherein the step of mapping comprises establishing a bounding box for the object, segmenting the bounding box into regularly sized cells based on a granularity setting.

22. The computer readable medium of claim 21 wherein the step of building a vertex collapsion heap includes storing pairs of boundary vertices within each cell of the vertex face array.

23. The process of claim 22 wherein the step of creating a vertex collapsion heap comprises at least one or more of the steps of: determining whether the distance between members of a vertex pair is less than a tolerance factor; determining that members of a vertex pair are not on the same polygon face; determining that no face inversion exists between members of the pair.

24. The process of claim 20 wherein the step of processing the collapsion heap includes for at least a first vertex pair, substituting a second vertex for a first vertex in the pair.

25. The process of claim 24 wherein the step of processing includes removing any heap elements containing said first vertex.

26. The process of claim 24 further including the step of determining a whether the substituted second vertex is a boundary vertex.
